(19) United States
(12) Patent Application Publication
(10) Pub. No.: US 2018/0341989 A1
(43) Pub. Date: Nov. 29, 2018

(54) Systems and Methods for Providing Real-Time Values Determined Based on Aggregated Data From Disparate Systems

(71) Applicant: Collective, Inc., New York, NY (US)

(72) Inventors: John Reim, New York, NY (US); Sriram Eswaran, East Brunswick, NJ (US); Ashley Herzog Kirchgessner, Brooklyn, NY (US); Jaisimha Muthegere, Bangalore (IN)

(21) Appl. No.: 15/988,850

(22) Filed: May 24, 2018

Related U.S. Application Data
(60) Provisional application No. 62/510,891, filed on May 25, 2017.

(51) Int. Cl. G06Q 30/02; G06F 17/30

(52) U.S. Cl. CPC G06Q 30/0273; G06F 17/3012; G06F 17/30106

(57) ABSTRACT

In accordance with embodiments of the present disclosure, each third party system of multiple of third party systems is configured to store files including datasets of different types, associated with one or more campaigns. Each dataset can be associated with a unique transaction ID. A computing system can be in communication with the third party systems and include a first database and a second database. The computing system can be configured to receive a selection of one or more third-party systems. The computing system can aggregate each of the datasets from the one or more files into one or more groups based on the unique transaction ID associated with each of the datasets, calculate one or more values associated with the at least one campaign, and generate a report including the one or more values.

### CROSS-REFERENCE TO RELATED PATENT APPLICATIONS

This application claims priority to U.S. Provisional Application No. 62/510,891 filed on May 25, 2017, the content of which is hereby incorporated by reference in its entirety.

### BACKGROUND

Executing and tracking digital media campaigns can be a cumbersome and error-prone process. Multiple vendors can track delivery of digital media campaigns for billing purposes. These vendors can include, for example, ad servers, execution platforms, and measurement platforms. Each of these vendors have their own mechanism for tracking delivery of any given digital media campaign. As a result, discrepancies between systems can be common and a burden to manage. These discrepancies can cause many problems, including for example: 1) uncertainty of campaign pacing and delivery; and 2) dispute over billing records. Existing techniques for managing such discrepancies are, in general, manual, time-consuming, cumbersome, and inaccurate.

### SUMMARY

According to various embodiments, a system and method are provided for system to provide real-time values determined based on aggregated data from disparate systems. The described systems and methods are directed to accurately tracking and reporting on cost values related to advertising expenditures from disparate vendors, and to create billing reports based on accurate data from all such vendors. In this regard, the describe systems and methods provide mechanisms by which advertisers can avoid the need to compile reporting from each vendor separately, or to rely on inaccurate calculations based on other data sources to estimate their costs and revenue prior to receiving invoices from vendors. The vendors can be embodied as third party systems.

In at least one embodiment, the described system is ingests impression-level and/or aggregated data from multiple third party systems (i.e., vendors) that are involved in an advertising campaign. The system calculates costs and fees associated with the services of such third party systems, so as to provide an accurate depiction of cost and ROI for advertisers. In at least one embodiment, calculations are performed in real-time or near-real-time.

In accordance with embodiments of the present disclosure, each third party system of multiple of third party systems is configured to store files including datasets of different types, associated with one or more campaigns. Each dataset can be associated with a unique transaction ID. A computing system can be in communication with the third party systems and include a first database and a second database. The computing system can be configured to receive a selection of one or more third-party systems. Each of the one more third-party systems is configured to store one or more files of the plurality of files, including datasets associated with at least one campaign of the one or more campaigns. The computing system can further stream the one or more files including the datasets associated with the at least one campaign from each of the one or more third party systems, aggregate each of the datasets from the one or more files into one or more groups based on the unique transaction ID associated with each of the datasets, and store the one or more groups of the datasets in the first database. The computing system can retrieve information associated with the at least one campaign and a user of the user device from the second database, calculate one or more values associated with the at least one campaign based on the one or more groups of datasets and the information associated with the at least one campaign and a user, and generate a report including the one or more values.

A user device can be associated with the user and in communication with the computing system. The user device can be configured to transmit the selection of one or more third party systems. A streaming platform residing on the computing system can be configured to stream each of the one or more files of the plurality of files to at least one topic based on the types of the datasets included in the one or more files.

In one embodiment, the computing system is further configured to breakdown the datasets from the one or more files, filter the datasets, and normalize the datasets. The computing system is further configured to apply one or more tags to each of the plurality of third-party systems, and generate the unique transaction IDs associated with each of the datasets based on the one or more tags applied to each of the plurality of third-party systems. Filtering the datasets includes removing at least one dataset associated with an invalid unique transaction ID. A third database in communication with the computing system configured to store metadata associated with the at least one campaign.

In one embodiment, at least one of the one or more files includes datasets associated with events. The computing system is configured to capture a URL associated with the events of the datasets from the at least one of the one or more files, determine device and browser information associated with the events, and determine a geographic location associated with the events. The user device includes a display configured to render the generated report.

Embodiments of the disclosed systems and methods ingest digital campaign delivery, performance and quality data feeds from each of a number of third party systems (i.e., vendors). The ingested data is then joined together using a common event-level identifier (i.e., unique transaction ID), and is further combined with contract information (i.e., information associated with the user) specific to each client (i.e., user). The resulting information is then used to automatically generate accurate cost reporting and billing reports. Costs can thereby be analyzed, in a single location, down to the impression level. Additionally, the accurate and automatic aggregation of costs into one system makes it possible for clients to be billed on a “Cost of Goods Sold +” model, directly tying the fees charged for managing a campaign with the cost to deliver it. In addition, client-specific contract terms for third party system usage can be applied at an impression level to accurately calculate cost for each impression.

In this manner, the described system provides improvements over conventional practices wherein finance teams need to reconcile individual reports from each third party systems, and only then create an accurate picture of the costs incurred on a campaign, all without the ability to track discrepancies to the impression level. The system described herein allows users to track their costs and thereby manage their margins in near real-time, and also cuts out a great deal of manual work done by finance teams.

Any combination and permutation of embodiments is envisioned. Other objects and features will become apparent from the following detailed description considered in conjunction with the accompanying drawings.

### BRIEF DESCRIPTION OF DRAWINGS

The accompanying figures, which are incorporated in and constitute a part of this specification, illustrate one or more embodiments of the present disclosure and, together with the description, help to explain embodiments of the present disclosure. The embodiments are illustrated by way of example and should not be construed to limit the present disclosure. In the figures:

FIG. 1 is network diagram of a system for providing real-time values determined based on aggregated data from disparate systems in accordance with and exemplary embodiment;

FIG. 2 illustrate an architecture for implementing the system for providing real-time values determined based on aggregated data from disparate systems in accordance with and exemplary embodiment;

FIG. 3 illustrates an architecture for implementing the delivery and log ingestion in accordance to an exemplary embodiment;

FIG. 4 illustrates tags which can be applied while implementing system for providing real-time values determined based on aggregated data from disparate systems in accordance with and exemplary embodiment;

FIGS. 5-8 illustrate exemplary Graphical User Interfaces (GUIs) in accordance with an exemplary embodiment;

FIG. 9 illustrates a computing device in accordance with an exemplary embodiment; and

FIGS. 10-12 are flowcharts illustrating an exemplary process performed while implementing the system for providing real-time values determined based on aggregated data from disparate systems according to an exemplary embodiment.

### DETAILED DESCRIPTION

In accordance with embodiments of the present disclosure, each third party system of multiple of third party systems is configured to store files including datasets of different types, associated with one or more campaigns. Each dataset can be associated with a unique transaction ID. A computing system can be in communication with the third party systems and include a first database and a second database. The computing system can be configured to receive a selection of one or more third-party systems. Each of the one more third-party systems is configured to store one or more files of the plurality of files, including datasets associated with at least one campaign of the one or more campaigns. The computing system can further stream the one or more files including the datasets associated with the at least one campaign from each of the one or more third party systems, aggregate each of the datasets from the one or more files into one or more groups based on the unique transaction ID associated with each of the datasets, and store the one or more groups of the datasets in the first database. The computing system can retrieve information associated with the at least one campaign and a user of the user device from the second database, calculate one or more values associated with the at least one campaign based on the one or more groups of datasets and the information associated with the at least one campaign and a user, and generate a report including the one or more values.

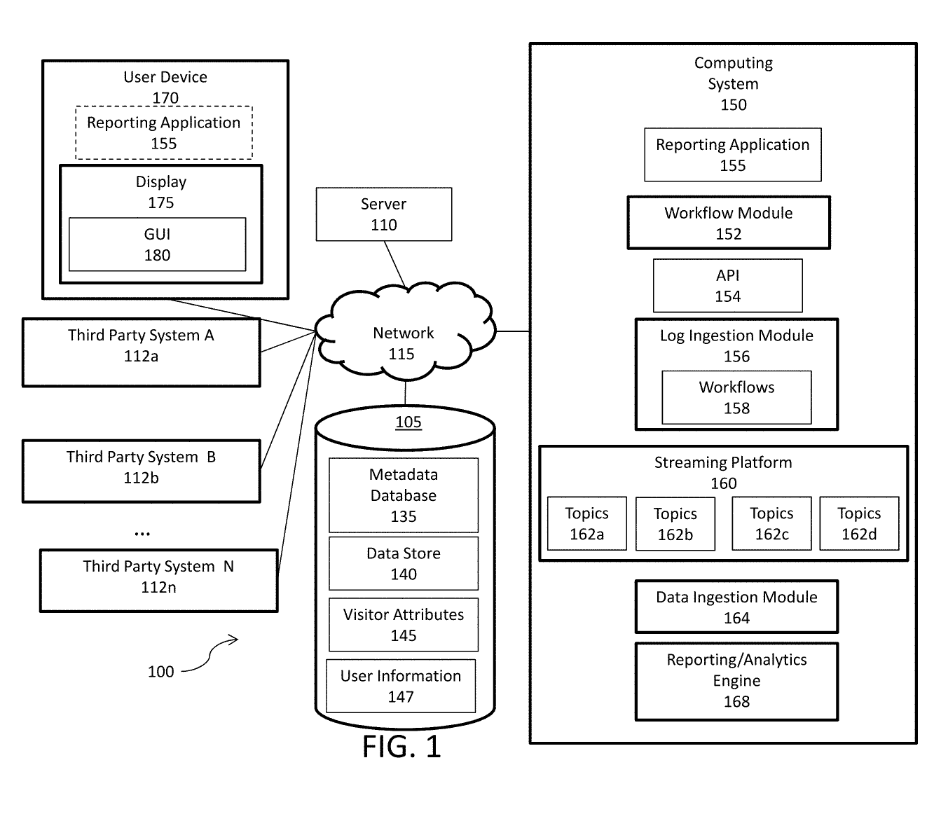

FIG. 1 is network diagram of a system 100 for providing real-time values determined based on aggregated data from disparate systems in accordance with and exemplary embodiment. The system 100 for providing real-time values determined based on aggregated data from disparate systems can include one or more data sources 105, one or more servers 110, one or more third party systems A-N 112a-n, one or more computing systems 150, and one or more user devices 170. The computing system 150 can be in communication with the data sources 105, server(s) 110, the third party systems A-N 112a-n, and the user devices 170, via a communications network 115.

The computing system 150 can execute a reporting application 155, workflow module 152, log ingestion module 156, data ingestion module 164, and a reporting/analytics engine 168 to implement the system 100 for providing real-time values determined based on aggregated data from disparate systems. The computing system 150 can also include a streaming platform 160 and an Application Program Interface (API) service 154 to communicate with the streaming platform 160. The one or more user devices 170 can execute an instance of the reporting application 155, hosted by the computing system 150, and/or can interface with the computing system, which can execute an instance of the application on behalf of the one or more user devices 170. The one or more user devices 170 can include a display 175 for rendering a graphical user interface (GUI) 180.

In an example embodiment, one or more portions of the communications network 115, can be an ad hoc network, a mesh network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

The server 110 includes one or more computers or processors configured to communicate with the computing system 150, third party systems A-N 112a-n, and user devices 170, via the communications network 115. The data sources 105 may store information/data, as described herein. For example, the data sources 105 can include multiple databases, including a metadata database 135, a data store database 140, a visitor attributes database 145, and a user information database 147. The metadata database 135 can store metadata associated with campaigns. The data store database 140 can data associated with campaigns ingested from the third party systems A-N 112a-n. The visitor attribute database 145 can store data associated with data derived/calculated/determined during an enrichment process. The user information database 147 can store information associated with users such as information associated a user's contracts with the third party systems A-N 112a-n for services provided to the user. The data sources 105 can be located at one or more geographically distributed locations from the computing system 150. Alternatively, the data sources 105 can be located at the same geographically as the computing system 150.

In one embodiment, the computing system 150 can receive a request to initiate a campaign and a selection of third party systems A-N 112a-n, from the user device 170. The computing system 150 can execute the workflow module 152 in response to receiving request to initiate a campaign and a selection of third party systems A-N 112a-n. The workflow module 152 can call the API service 154 to initiate a campaign setup, specifying the selection of third party systems A-N 112a-n to be included in the campaign as well as the metadata associated with the campaign.

The API service 152 can store the metadata associated with the campaign in the metadata database 135. As a non-limiting example, the metadata can include one or more of campaign ID, line ID, ad ID, and creative ID. The API service 152 can create workflows 158 in the log ingestion module 156 for each of the selected third party systems A-N 112a-n. Each of the workflows 158 can download files from each of the selected third party systems. The files can include can be impression/event-level logs associated with the campaign. Impressions can be embodied as a view or ad view referring to a point at which an ad is viewed by a user and/or displayed on a web page. The number of impressions of a particular campaign can be determined by the number of times a particular webpage with the advertisement is located and/or loaded. As an example, the files can be posted by the third party systems A-N 112a-n to a Secure File Transfer Protocol (SFTP), File Transfer Protocol (FTP), Google Cloud Storage, and/or Amazon Web Services (AWS) S3 bucket.

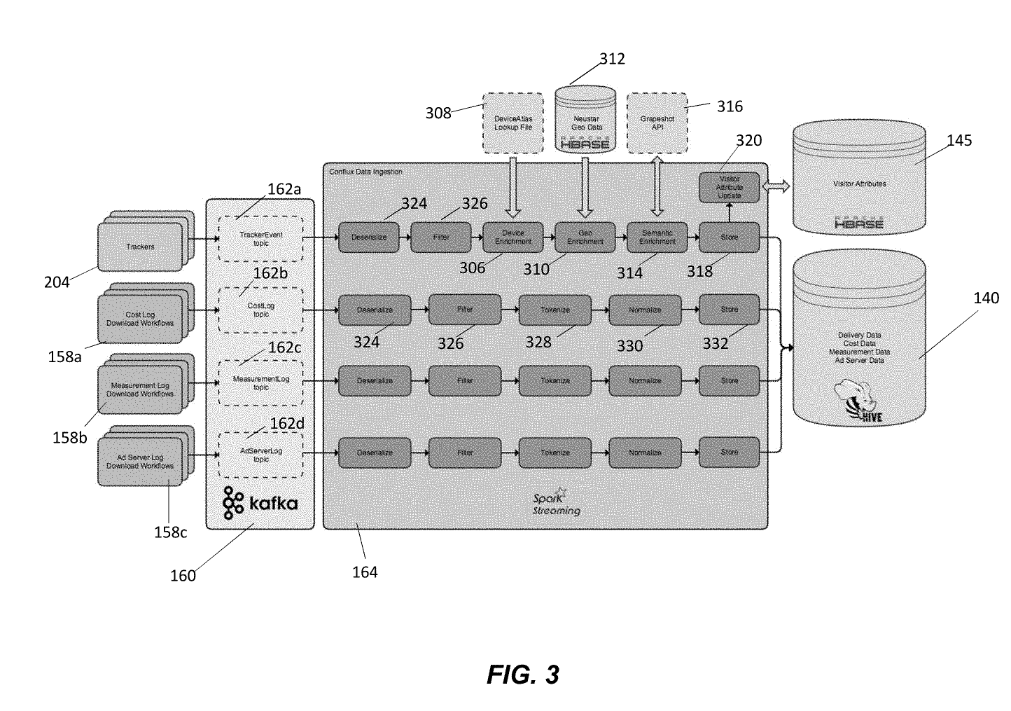

Each workflow 158 streams the downloaded files to a specific topic 162 in a streaming platform 160. In one embodiment, the topics 162 can be associated with a type of third party system A-N 112a-n. The workflows 158 can stream the files to the respective topics 162 based on the type of third party system A-N 112a-n the files were downloaded from. The data ingestion module 164 can execute an enrichment and/or an extract, transform, load (ETL) process on the files streamed in the different topics 162. During the ETL process, the data ingestion module 164 can break down the datasets from the files. Each of the datasets can be associated with a unique transaction ID. The data ingestion module 164 can validate the unique transaction ID, aggregate, join, and/or merge datasets from different third party systems A-N 112a-n, based on the unique transaction ID. The enrichment and ETL process will be described in further detail with respect to FIG. 3. The data ingestion module 164 can read the datasets in the log lines of the files from each respective topic, map the datasets from the log lines into fields of a common (normalized) format, transform the datasets, and load the datasets for storage in the data store database 140.

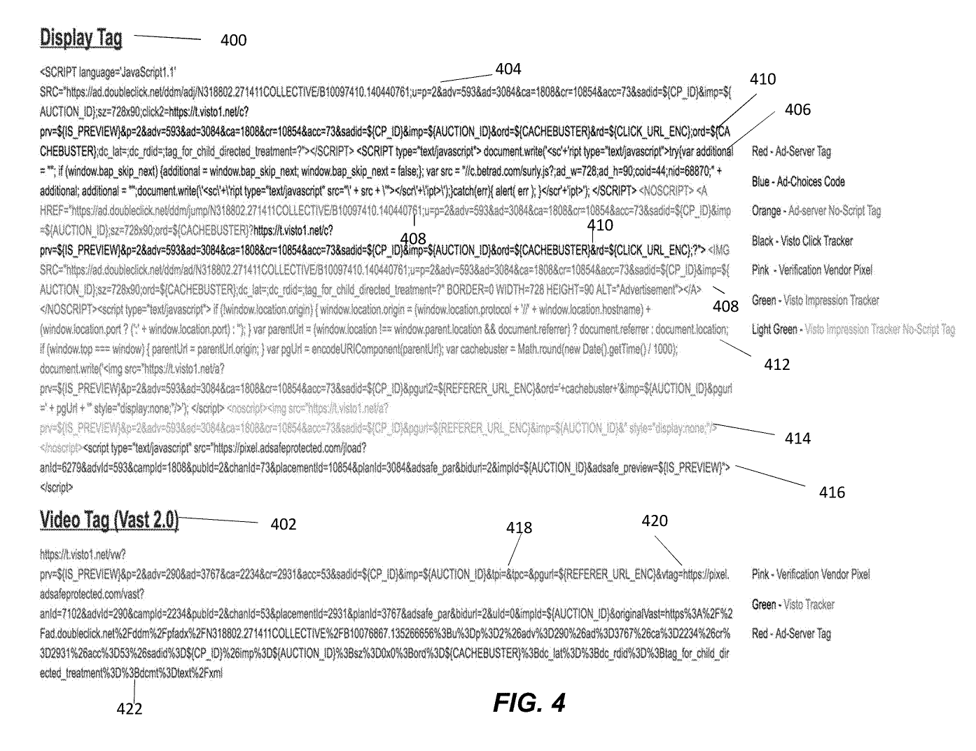

A unique transaction ID can be assigned to each dataset in each of third party system using tags disseminated by the computing system 150. The tags can be code (e.g., HTML) embedded in and assigned to datasets such as impressions, links, and/or other event level data associated with a particular campaign. The tags can identify types of datasets. For example, the tag can be a display tag, a video tag, creative tag, and/or a specialized tag. The unique transaction ID can be generated at execution of an impression. Tags will be described in further detail with respect to FIG. 4.

The reporting/analytics engine 168 can retrieve/read the datasets stored in the data store database 140. Additionally, the reporting/analytics engine 168 can retrieve information associated with the user of the user device, from the user information database 147. For example, the information associated with the user of the user device can be contract data associated with contract for services between the user and the third party systems A-N 112a-n. The reporting/analytics engine 168 can calculate values associated with the campaign using the aggregated datasets from the groups and the contract data. The reporting analytics engine 168 can generate a report including the calculated values.

The reporting application 155 can generate a GUI 180 rendering the generated report. The instance of the reporting application 155 executing on the user device 170 can render the GUI 180 on the display 175 of the user device.

As a non-limiting example, the system 100 for providing real-time values determined based on aggregated data from disparate systems, can be implemented to costs and billing of services provided for digital media ad campaigns. The system 100 for providing real-time values determined based on aggregated data from disparate systems can calculate costs and fees associated with the services to provide an accurate depiction of cost and return of investment (ROI). The user device 170 can be associated with a user implementing a digital media campaign. The user can be an entity such as a company, organization, corporation, partnership, individual, educational institution, and/or any other type of entity implementing digital media campaigns. The third party systems A-N 112a-n can be vendors associated with a digital media ad campaign. The contracts for services can be between the user of the user device and the vendors. The services can be for providing digital media campaigns. For example, the services can be associated with displaying links, videos, images, and other ad material on a vendor's website. The vendors can be one or more of trackers, an ad server, an execution platform, and a measurement platform. The files received from vendors can include datasets associated with at least one of, trackers (a proprietary data source), cost data, measurement data, and ad server data. The trackers can track real-time events on digital media (e.g., the internet), such as click counts. In this regard, the files associated with the trackers can include event level data. The attributes associated with the real-time events on digital medial derived/calculated/determined during an enrichment process can be stored in the visitor attributes database 145. The calculated values associated with the campaign using the aggregated datasets from the groups and the contract data included on the generated report can be cost and billing reporting.

In at least one embodiment, users can input rates (as defined by their own contracts with that vendor) for specific services from each vendor that can be used in the delivery and measurement of a digital media ad impression, via the user device 170. The user device 170 can transmit the input rates to the computing system 150. In the event the service is included in the delivery/measurement of a digital media ad, a tracking URL for that vendor is included in the tag, such as an ad tag, which is disseminated to the vendor. An event/impression associated with the digital media ad can be tracked based on the tag. Datasets including event and/or impression data and any other relevant data can be ingested by the computing system 150, as described above. The reporting/analytics engine 170 can apply the received input rates for the specified vendor and the service that was used on the digital media ad impression to accurately calculate the cost to be applied.

Data associated with each vendor involved in the digital media campaign, along with the combination of each creative and ad, can be stored to provide a high level of granularity for reporting. The contract data associated with each vendor can be applied to determine and represent costs incurred on each impression served through a particular creative and ad combination.

The calculated costs can be then aggregated for use in a reporting user interface (UI) and to generate monthly billing reports. The reports can be rendered on the GUI 180 of the display 175 of the user device 170. Users can use this information to accurately manage costs for their campaign while it is running. In at least one embodiment, the system uses such cost information to generate an invoice for every campaign run through the system.

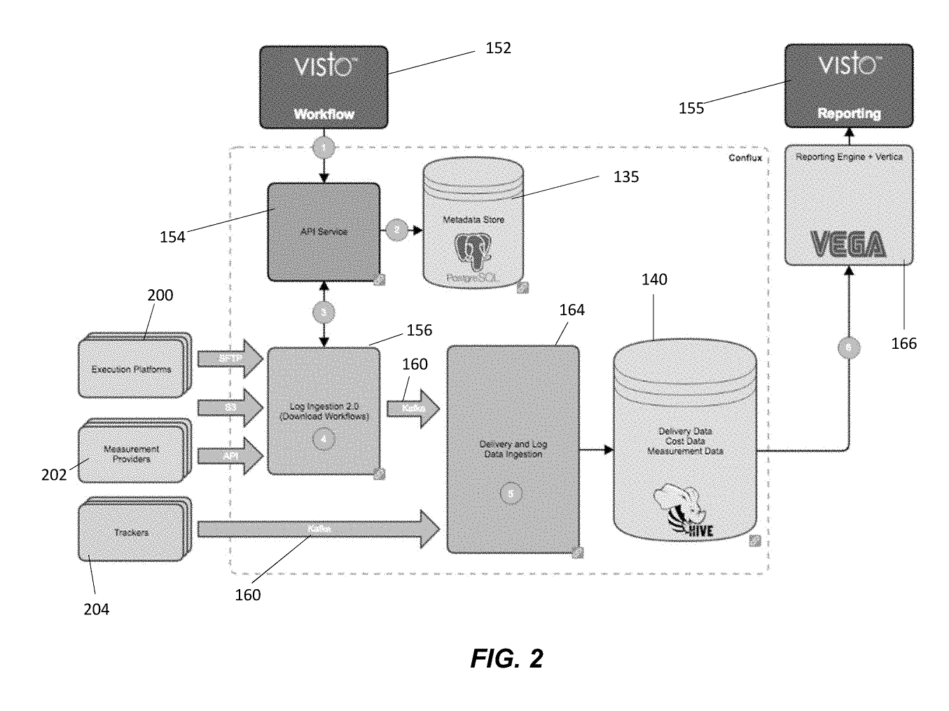

FIG. 2 illustrates an architecture 200 for implementing the system for providing real-time values determined based on aggregated data from disparate systems in accordance with and exemplary embodiment. A workflow module 152 can API service 154 to initiate a campaign setup, specifying the specific vendors to be included in the campaign and on which vendor to execute the campaign buying, as well as credentials for each vendor. The vendor can be a third party system (e.g., third party system A-N 112a-n). As an example, the vendors can be execution platforms 200, measurement providers 202, and trackers 204. The workflow module 152 can be embodied as a Visto™ Workflow. The workflow module 152 can also provide the API service 154 metadata associated with the campaign. The API Service 154 can store metadata provided by workflow module 152 in a metadata database 135. The metadata database 135 can be embodied as a Postgres database.

The API Service 154 can create workflows in the log ingestion module 156. The log ingestion module 156 can be embodied as Conflux. The workflows can download files such as impression/event-level logs for each of the vendors used by the client. As an example, the execution platforms 200 and measurement providers 202 can post log files to an SFTP location, an FTP location, Google Cloud Storage, and/or AWS S3 bucket. The workflows can stream the files into topics in a streaming platform 160 such as Apache Kafka. Apache Kafka is a streaming platform which allows systems and users to subscribe and publish data to any number of systems and real-time applications. The data can be received by Apache Kafka and partitioned by topics. The topics can be specified. For example, the topics can be specified based on the type of dataset (i.e., trackers, cost data, measurement data, and/or ad server data). Trackers 204 can stream respective files directly to the streaming platform 160.

The data ingestion module 164 can receive the streamed files from the different topics from the streaming platform 160. The data ingestion module 164 can read the datasets in the log lines of the files from each respective topic, map the datasets from the log lines into fields of a common (normalized) format, transform the datasets, and load the datasets for storage in the data store database 140. The data ingestion module 164 also receives delivery events streamed by trackers 204, from the streaming platform 160, performs various enrichments to these events, and streams the events into HDFS/Hive. The data store database 140 can be embodied as Hadoop Distributed File System (HDFS)/Hive data warehouse.

A reporting/analytics engine 166 can include a reporting platform and an analytics platform. The reporting/analytics engine 166 can calculate values associated with the campaign, as described above. The reporting platform reads and/or retrieves the datasets from the data store database 140 and loads it into an analytics platform. The analytics platform can execute necessary aggregations to generate a report including the calculated values. The reporting platform can be embodied as Vega and the analytics platform can be HPE Vertica. The analytics platform can provide the discrepancy report to a reporting application 155 to provide the discrepancy report to a user device (e.g., user device 170 as shown in FIG. 1). The reporting application 155 can be embodied as Visto™ Reporting.

FIG. 3 illustrates an architecture 300 for implementing the Delivery and Log Ingestion module in accordance to an exemplary embodiment. As described with respect to FIG. 2, impression/event-level log files are received from different third party systems (vendors) and is classified, based on the type of third party systems: Trackers (a proprietary data source), cost data, measurement data, and ad server data. Workflows are generated based on the type of dataset and/or third party system. As an example, a cost log download workflow 158a, a measurement log download workflow 158b, and an ad server log download workflow 158c, can be created. As also described with respect to FIG. 2, files are posted by the third party systems to an SFTP location, an FTP location, Google Cloud Storage, and/or an AWS S3 bucket. The files are downloaded from the respective locations and streamed to a streaming platform 160 (i.e., Apache Kafka). The streaming platform 160 can convert the files into a Java stream. The Java stream can be loaded into a streaming application on used by the data ingestion module 164, such as Conflux spark. Files including event level datasets can be streamed from trackers 204 to the streaming platform 160.

The streaming platform 160 can partition the incoming files by topics. As shown in FIG. 3, the trackers 204 can stream files including event level data to the trackers topic 162a, cost log download workflow 158a can stream cost log files into the cost log topic 162b, the measurement log download workflow 158b can stream the measurement log files to the measurement log topic 162c, and the ad server download workflow 158c can stream the ad server log files to the ad server log topic 162d. In response to being loaded into the data ingestion module 164, the data ingestion module 164 can execute the ETL process, the cost log files, measurement log files, and the ad server log files.

The ETL process can include a deserialization operation 324, a filtering operation 326, a tokenization operation 328, a normalization operation 330, and a store operation 332. In the deserialization operation 324 the datasets in the cost log, measurement log, and ad server files is broken down to extract the raw data from the files and create new objects. In the filtering operation 326, the datasets and/or event level data that do not have a valid transaction ID can be removed. The transaction ID can be a unique ID generated at the execution of an impression that is disseminated to the third party systems through a tag. As described above, tags can be code such as HTML, used to track/identify datasets in third party systems, such as event and/or impression level data. In the filtering operation 326, datasets associated with any impression that is flagged as having been served to an IP address marked by the IAB Bots and Spiders List as non-human traffic, can be removed.

In the tokenization operation 328, the datasets from different third party systems can be aggregated, joined, and/or merged based on the transaction ID associated with each of the datasets. During the tokenization operation 328 each of the datasets can be aggregated from the one or more files, into one or more groups based on the unique transaction ID associated with each of the datasets. The datasets associated with impression event records from different third party systems can be matched (i.e., grouped). The data points passed from each third party system can be broken down into distinct objects so the datasets can be reassembled into a coherent dataset. In the normalization operation 330, the datasets from the different third party systems can be reassembled into a Visto™ data format (columns) that allows for creation of a readable dataset combining data from all third party systems. In the store operation 332, the reassembled datasets are prepared and stored in the data store database 140 (i.e., Hive data warehouse).

The data ingestion module 160 can execute an enrichment process on the event level data streamed through the trackers 204. The enrichment process can include a deserialization operation 324, a filtering operation 326, a device enrichment operation 306, a geographic (geo) enrichment operation 310, a semantic enrichment operation 314, and a store operation 318. The deserialization operation 324, and filtering operation 326, can be executed as described above with respect to the ETL process. In the device enrichment process 306, the device and (internet) browser data associated with the event level data can be determined based on a user agent from the (internet) browser associated with the event level data, using a file provided by a DeviceAtlas source 308. The DeviceAtlas source can be used to analyze web traffic device detection. The DeviceAtlas source is a platform configured to provide data on all mobile and connected devices including smartphones, tablets, laptops, and wearable devices. It can be appreciated sources other than the DeviceAtlas source can be used to provide the same data.

In the geographic enrichment operation 310, IP addresses of the user viewing the impression event associated with the event level data can be extracted. A file provided by a source such as Neustar 312 can be used to look up the geographic location of the IP address. Neustar 312 is a platform that can provide real-time information and analytics. It can be appreciated sources other than the Neustar 312 can be used to provide the same data.

In the semantic enrichment operation 314, a Uniform Resource Locator (URL) from a website of the impression event associated with the event level data is captured and transmitted to a context marketing engine 316 such as Grapeshot. The context marketing engine can return a specified number (i.e., top five) classification (in IAB categories) for the website. Grapeshot is a platform to segment inventory and improve target marketing. It can be appreciated sources other than the Grapeshot can be used to provide the same data.

In the store operation 318, the resultant data from the deserialization operation 324, filtering operation 326, device enrichment operation 306, geographic (geo) enrichment operation 310, and semantic enrichment operation 314 can be stored in the data store database 140. Additionally, the resultant data from the device enrichment operation 306, geographic (geo) enrichment operation 310, and semantic enrichment operation 314 can be stored as user attribute data in the visitor attribute database 145.

In one embodiment, the system ingests datasets from files, from different impression-level and aggregated streams. Such datasets can come directly from each vendor involved in serving or measuring an impression. Once the data is ingested, an ETL process is executed to join data together based on a transaction ID passed to each vendor via creative tags.

FIG. 4 illustrates tags which can be applied while implementing the system for providing real-time values determined based on aggregated data from disparate systems in accordance with and exemplary embodiment. Tags can be used to track/identify datasets in third party systems, such as event and/or impression level data. In one embodiment, one or more specialized tag(s) can be applied to leverage functionality of existing ad servers, to provide the ability to incorporate reporting benefits offered by adding tracking URLs from multiple third party systems (vendors) involved in the ad delivery and management process (ad servers, measurement partners, etc.). In this regard, the system is able to generate a unified reporting experience (i.e., the discrepancy report) that combines the authoritative ad server data with quality information provided by a verification/measurement provider, real-time feedback provided by a tracking module, and information obtained from other third party systems participating in the digital media campaign (such as an execution partner). In one embodiment, tags are customized to produce a combination of URLs, custom parameters, and macros for each possible group of vendors leveraged on a campaign.

As an example, a display tag 400 and a video tag 402 can be applied by the disclosed system. The display tag 400 and video tag 402 demonstrate various parameters and URLs/trackers that can be assembled using the techniques described herein. The code 404 and 408 under the display tag 400, references the original ad tag provided by the ad server. The code 412 and code 414 under the display tag 400 references the impression tracking mechanism from the Visto™ tracker. The code 410 under the display tag 400 references the click-tracking mechanism from the Visto™ tracker. The codes 412, 414, and 410 can be added automatically during the tag assembly process. The code 416 under the display tag 400 references optional tracking mechanisms for verification or ad quality measurement vendors for the purpose of tracking and comparing impression management. The code 406 under the display tag 400 references ad-choices code.

The code 418 under the video tag 402 references a tracking mechanism from the Visto™ Tracker. The code 420 under the video tag 402 references optional tracking mechanisms for verification or ad quality measurement vendors for the purpose of tracking and comparing impression management. The code 422 under the video tag 402 references the original ad tag provided by the ad server. One skilled in the art will recognize that these are merely examples, and that other types of tags can be used, provided, and/or applied.

Data from the respective third party systems (vendors), such as impression and click counts, viewable and measurable impression counts, etc., can be combined with the metadata such as campaign ID, line ID, ad ID and creative ID, that has been stored about campaigns in the metadata database (e.g., metadata database 135 as shown in FIGS. 1-2). Information on each third party system which is applied to each impression can be stored. Data associated with each third party system involved in a campaign (i.e., digital media campaign) that needs to be applied on an impression can also be stored. The combination of each creative and ad is stored. This data is surfaced and made available within the discrepancy report (for example, as part of a pre-built “Performance Report”). A discrepancy calculation is automatically applied to the data to make it readily available to users.

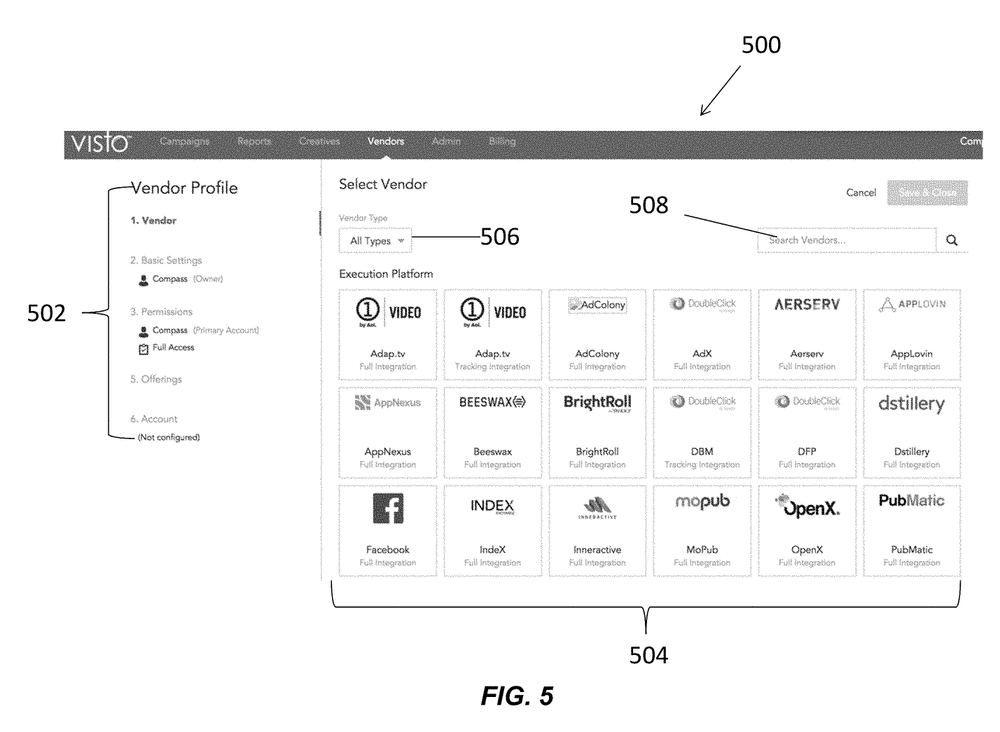

FIGS. 5-8 illustrate exemplary Graphical User Interfaces (GUIs) in accordance with an exemplary embodiment. With reference to FIG. 5, a Select Vendor GUI 500 can be rendered on the display (i.e., display 175 as shown in FIG. 1) of the user device 170 (i.e., user device as shown in FIG. 1) according to one embodiment. The Select Vendor GUI 500 can include a selection of vendors 504, a dropdown menu 506 to select a type of vendor to search, a search input box 508. A vendor profile 502 can be displayed adjacent to the selection of vendors 504, dropdown menu 506, and a search input box 508.

The selection of vendors 504 can include multiple vendors (i.e., third party systems) associated with one or more campaigns. A user using the user device can select a vendor out of the vendor selection 504. In response to selecting the vendor from the vendor selection 504, the vendor profile 502 of the selected vendor can be displayed. The user can manage services and rates to be made available and applied to the vendor's campaigns. A user can filter the vendors by type using the dropdown menu 506. Additionally, the user can search for specific vendors using the search input box 508. The search input box 508 can receive alphanumeric input.

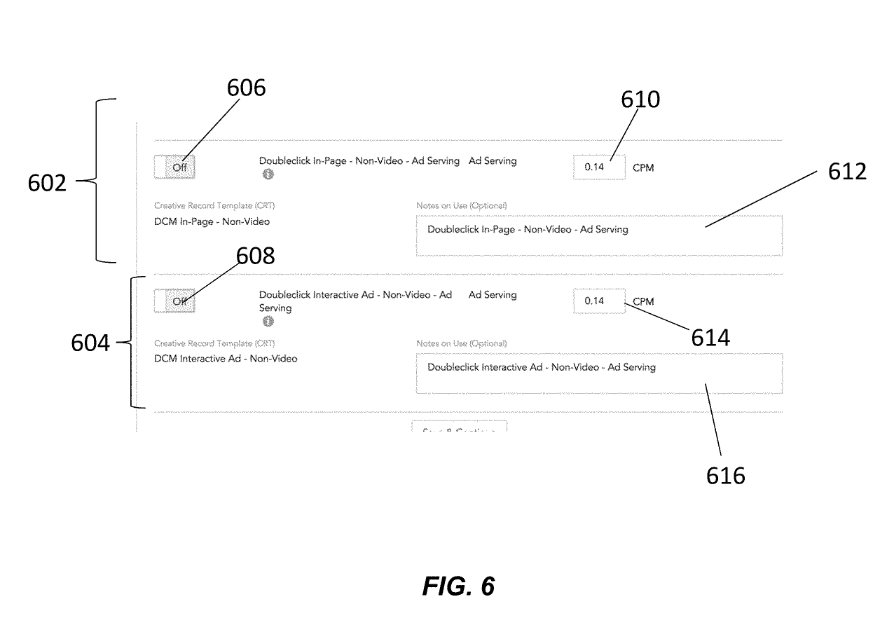

With reference to FIG. 6, a Vendor Offering GUI 600 can be displayed on the display (i.e., display 175 as shown in FIG. 1) of the user device 170 (i.e., user device as shown in FIG. 1). The Vendor Offering GUI 600 can include modifiable details of services provided by vendors (i.e., third party systems) associated with campaigns. As an example, the Vendor Offering GUI can include details associated with services provided by the vendor such as an in-page—non-video ad 602 and details associated with an interactive—non-video ad 604. The details associated with in-page—non-video ad 602 and details associated with an interactive—non-video ad 604 can include an “on” and “off' toggle button 606 and 608, respectively. The details associated with in-page—non-video ad 602 and details associated with an interactive—non-video ad 604 can include an rate input box 610 and 614, respectively. The rate input boxes 610 and 614 can include rates for cost of an online ad per 1000 impressions (CPM). It can be appreciated other rate input boxes can be included to include other costs (e.g., rates for cost per click (CPC), cost per acquisition (CPA), or click-through rate (CTR). A user can input the rates of the service provided by an individual vendor, so that the terms of the contract between the vendor and the user can be accurately reflected. These terms can vary between different companies/clients. The details associated with in-page—non-video ad 602 and details associated with an interactive—non-video ad 604 can include a notes input box 612 and 616, respectively. A user can enter notes in associated with the service in the notes input boxes 612 and 616. The notes input boxes 612 and 616 can receive alphanumeric text.

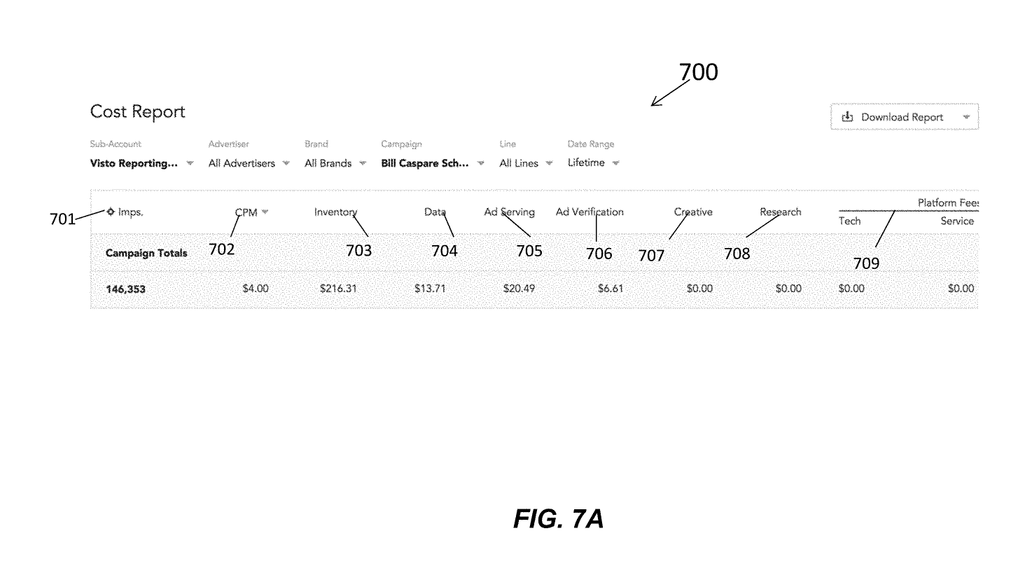

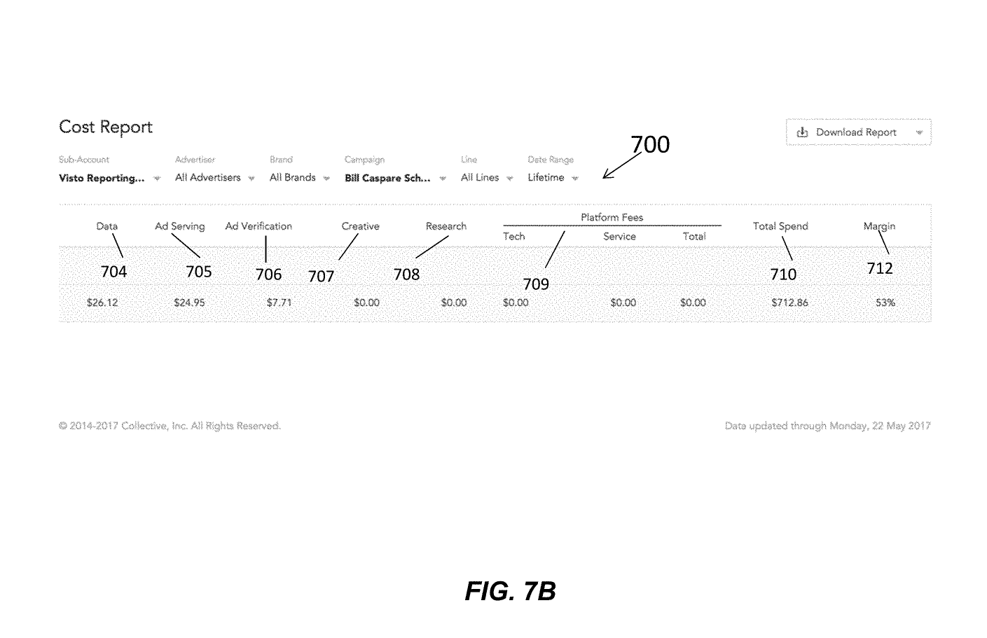

With reference to FIGS. 7A-7B, a Cost Report GUI 700 can be displayed on the display (i.e., display 175 as shown in FIG. 1) of the user device 170 (i.e., user device as shown in FIG. 1). The Cost Report GUI 700 can include the totaled calculated cost values (as described above) for a campaign in view of a user's contract details with the vendor (i.e., third party system). The costs for each are generated, for example, based on data passed by each vendor, and are calculated based on the rates defined in the vendor offerings. The Cost Report GUI 700 can include an imp field 701, metric field 702, inventory field 703, data field 704, ad serving field 705, ad verification field 706, creative field 707, research field 708, and a platform field 709.

The imp field 701 indicates the total number of Impressions delivered for the life of the campaign. The metric field indicates a selected primary Key Performance Indicator (KPI) for the campaign. Metrics for CTR, Action rate, CPA, CPC, CPM, and Views Through Conversion (VTC) can be displayed. The inventory field 703 can include a payout for a publisher (inventory costs) that consolidates all the impression-level information at the campaign level. The data field 704 can consolidate impression-level data costs that are incurred and associated with the campaign. The ad serving field 705 can consolidate any ad serving costs that are incurred for each impression associated with the campaign. The ad verification field 706 can include the total ad verification costs that are incurred for each impression associated with the campaign. The creative field 707 indicates costs that are incurred to create/serve rich media creatives for the execution of the campaign. The research field 708 shows the cost of market research if the research is utilized, consolidated at a campaign level. The Platform Fees field 709 includes a tech sub-field and a services sub-field. The Platform Fees field 709 indicates platform fee charged by an entity such as Collective for technology and services associated with the campaign. With specific reference to FIG. 7B, the Cost Reporting GUI 700 can include a total spend field 710 and a margin field 711, the total spend field 710 indicates a total spent value associated with the campaign. The margin field 711 indicates a percentage of earnings or profit for a user out of the total spent (if applicable).

A user can filter using the sub-account, advertiser and/or brand, to quickly and easily find data for a particular campaign. Additionally, the user can specify a date range to be included in the report, and can download the data into a file, such as a CSV-formatted file or the like.

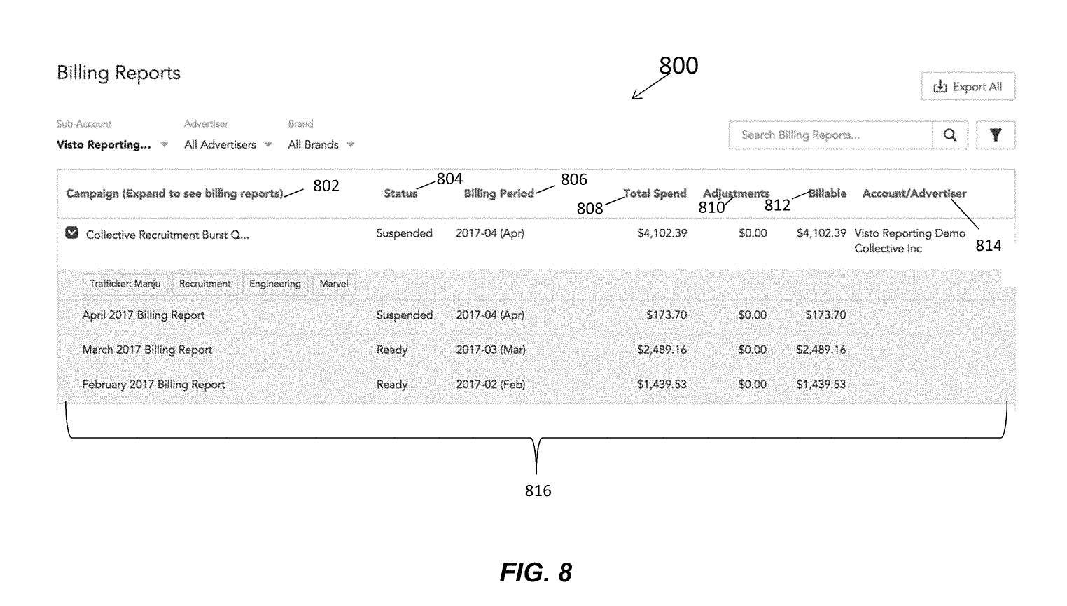

With reference to FIG. 8, a billing reports GUI 800 can be displayed on the display (i.e., display 175 as shown in FIG. 1) of the user device 170 (i.e., user device as shown in FIG. 1). The billing reports GUI 800 can include invoices generated for each month and grouped by campaign, and can further include any labels associated with the campaign for easy searching by finance or sales users. In at least one embodiment, the billing reports GUI 800 also displays the account and advertiser at each campaign for maximum clarity.

As an example, the invoice can include the following fields: campaign field 802 a status field 804, a billing period field 806, a total spend field 808, an adjustment field 810, a billable field 812, and an account/advertiser field 814. The campaign field 802 can include the name of the campaign. The status field 804 can include the status of a state of the invoice and ability to be used (i.e., Suspended or Ready). The billing period field 806, the month for which the invoice was generated. The total spend field 808 can include a total amount spent by the advertiser on a campaign, which can be a subtotal for the invoice. The adjustments field 810 can include a function to add or subtract value from the total spend to reflect any additional costs or credits that can be added. The billable field 812 can include a final billable amount to be sent in an invoice, net of any adjustments made. The account/advertiser field 814 can include the name of the account/advertiser. The billing reports GUI 800 can include previous month invoices 816 listed for selection below the current month invoice. A user can filter using the sub-account, advertiser and/or brand to find the most relevant invoices.

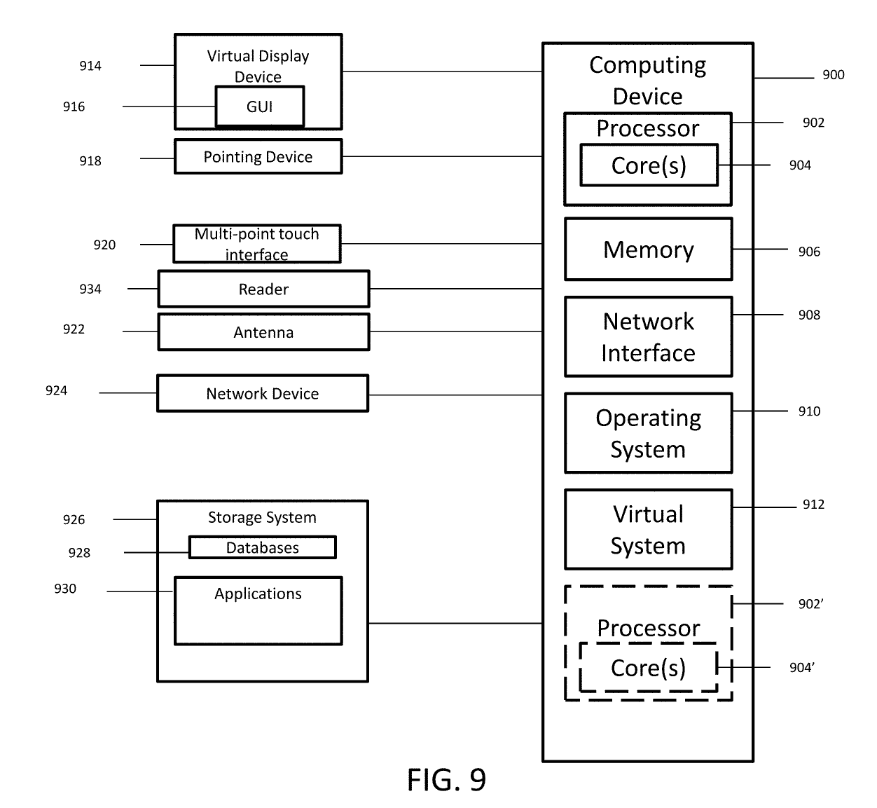

FIG. 9 is a block diagram of an example computing device for implementing exemplary embodiments. The computing device 900 may be, but is not limited to, a smartphone, laptop, tablet, desktop computer, server or network appliance. The computing device 900 can be embodied as part of the computing system, user device and/or third party systems. The computing device 900 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives, one or more solid state disks), and the like. For example, memory 906 included in the computing device 900 may store computer-readable and computer-executable instructions or software (e.g., applications 930 such as the reporting application 155, workflow module 152, API service 154, log ingestion module 156, streaming platform 160, data ingestion module 164, and reporting analytics engine 168) for implementing exemplary operations of the computing device 900. The computing device 900 also includes configurable and/or programmable processor 902 and associated core(s) 904, and optionally, one or more additional configurable and/or programmable processor(s) 902′ and associated core(s) 904′ (for example, in the case of computer systems having multiple processors/cores), for executing computer-readable and computer-executable instructions or software stored in the memory 906 and other programs for implementing exemplary embodiments. Processor 902 and processor(s) 902′ may each be a single core processor or multiple core (904 and 904′) processor. Either or both of processor 902 and processor(s) 902′ may be configured to execute one or more of the instructions described in connection with computing device 900.

Virtualization may be employed in the computing device 900 so that infrastructure and resources in the computing device 900 may be shared dynamically. A virtual system 912 may be provided to handle a process running on multiple processors so that the process appears to be using only one computing resource rather than multiple computing resources. Multiple virtual machines may also be used with one processor.

Memory 906 may include a computer system memory or random access memory, such as DRAM, SRAM, EDO RAM, and the like. Memory 906 may include other types of memory as well, or combinations thereof.

A user may interact with the computing device 900 through a visual display device 914, such as a computer monitor, which may display one or more graphical user interfaces 916, multi touch interface 920, and a pointing device 918.

The computing device 900 may also include one or more storage devices 926, such as a hard-drive, CD-ROM, or other computer readable media, for storing data and computer-readable instructions and/or software that implement exemplary embodiments (e.g., applications). For example, exemplary storage device 926 can include one or more databases 928 for storing data values for metadata, data extracted from third party systems associated to campaigns, visitor attribute data, and/or user information data. The databases 928 may be updated manually or automatically at any suitable time to add, delete, and/or update one or more data items in the databases.

The computing device 900 can include a network interface 908 configured to interface via one or more network devices 924 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the computing system can include one or more antennas 922 to facilitate wireless communication (e.g., via the network interface) between the computing device 900 and a network and/or between the computing device 900 and other computing devices. The network interface 908 may include a built-in network adapter, network interface card, PCMCIA network card, card bus network adapter, wireless network adapter, USB network adapter, modem or any other device suitable for interfacing the computing device 900 to any type of network capable of communication and performing the operations described herein.

The computing device 900 may run operating system 910, such as versions of the Microsoft® Windows® operating systems, different releases of the Unix and Linux operating systems, versions of the MacOS® for Macintosh computers, embedded operating systems, real-time operating systems, open source operating systems, proprietary operating systems, or other operating systems capable of running on the computing device 900 and performing the operations described herein. In exemplary embodiments, the operating system 910 may be run in native mode or emulated mode. In an exemplary embodiment, the operating system 910 may be run on one or more cloud machine instances.

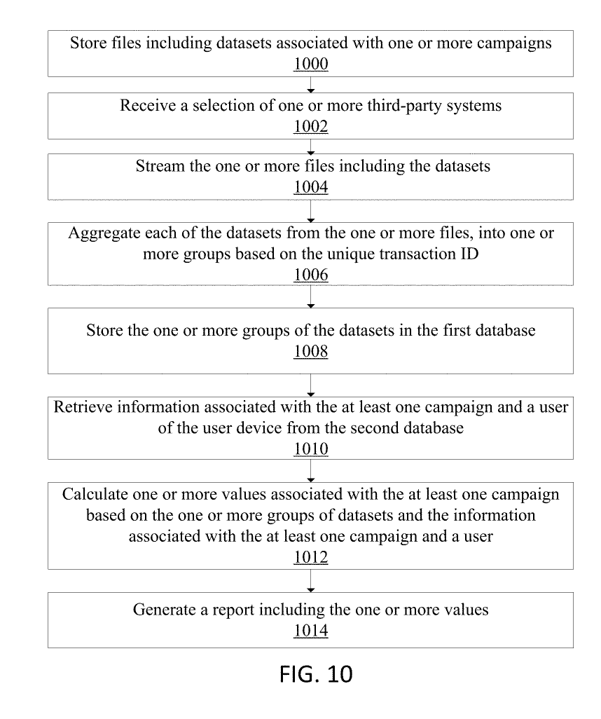

FIG. 10 is a flowchart illustrating an exemplary process performed in the system for determining data discrepancies between disparate systems in real-time. In operation, 1000, each of multiple third party systems (e.g., third party systems A-N 112a-n as shown in FIG. 1) can store files including datasets associated with one or more campaigns. In operation 1002, a computing system (e.g., computing system 150 as shown in FIG. 1) in communication with the third party systems, a user device (e.g., user device 170 as shown in FIG. 1) and including a first database (e.g., data store database 140 as shown in FIGS. 1-3) and a second database (user information database 145 as shown in FIG. 1), can receive a selection of one or more third-party systems from the user device. Each of the one more third-party systems is configured to store one or more files including datasets associated with at least one campaign.

In operation 1004, the computing system can stream the one or more files including the datasets associated with the at least one campaign from each of the one or more third party systems. In operation 1006 the computing system can aggregate each of the datasets from the one or more files, into one or more groups based on the unique transaction ID associated with each of the datasets. In operation 1008, the computing system can store the one or more groups of the datasets in the first database. In operation 1010, the computing system can retrieve information associated with the at least one campaign and a user of the user device from the second database. In operation 1012 the computing system can calculate one or more values associated with the at least one campaign based on the one or more groups of datasets and the information associated with the at least one campaign and a user. In operation 1014, the computing system can generate a report including the one or more values.

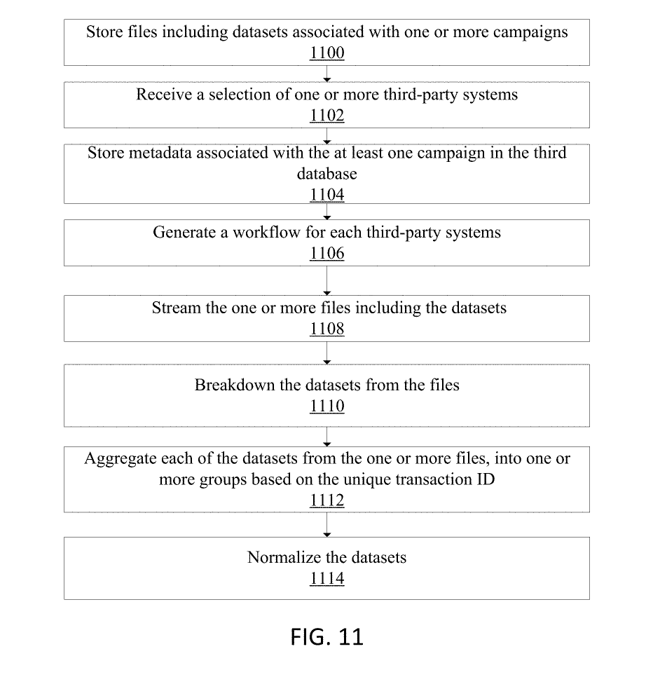

FIG. 11 is a flowchart illustrating an exemplary process performed in the system for determining data discrepancies between disparate systems in real-time. In operation, 1100, each of multiple third party systems (e.g., third party systems A-N 112a-n as shown in FIG. 1) can store files including datasets associated with one or more campaigns. In operation 1102, a computing system (e.g., computing system 150 as shown in FIG. 1) in communication with the third party systems, a user device (e.g., user device 170 as shown in FIG. 1) and including and including a first database (e.g., data store database 140 as shown in FIGS. 1-3) and a second database (user information database 145 as shown in FIG. 1), and in communication with a third database (metadata database 140 as shown in FIGS. 1-2), can receive a selection of one or more third-party systems from the user device. Each of the one more third-party systems is configured to store one or more files including datasets associated with at least one campaign.

In operation 1104, the computing system can store metadata associated with the at least one campaign in the third database. In operation 1106 the computing system can generate a workflow (e.g., workflows 162 as shown in FIG. 1) for each third-party systems of the one or more third party systems. In operation 1108, the computing system can stream the one or more files including the datasets associated with the at least one campaign from each of the one or more third party systems, via each respective workflow.

In operation 1110, the computing system can breakdown the datasets from the files. In operation 1112, the computing system can filter the datasets by removing any dataset associated with an invalid transaction ID. The transaction ID can be a unique ID generated for the dataset based on a one or more tags applied to each of the plurality of third-party systems. In operation 1114, the computing system can aggregate each of the datasets from the one or more files, into one or more groups based on the unique transaction ID associated with each of the datasets. In operation 816, the computing system can normalize the datasets.

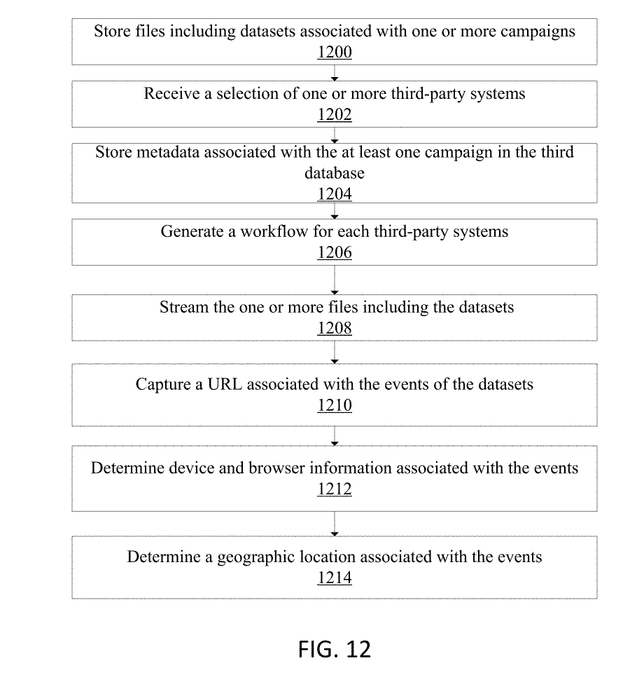

FIG. 12 is a flowchart illustrating an exemplary process performed in the system for determining data discrepancies between disparate systems in real-time. In operation, 1200, each of multiple third party systems (e.g., third party systems A-N 112a-n as shown in FIG. 1) can store files including datasets associated with one or more campaigns. In operation 1202, a computing system (e.g., computing system 150 as shown in FIG. 1) in communication with the third party systems, a user device (e.g., user device 170 as shown in FIG. 1) and including a first database (e.g., data store database 140 as shown in FIGS. 1-3) and a second database (user information database 145 as shown in FIG. 1), and in communication with a third database (metadata database 140 as shown in FIGS. 1-2), can receive a selection of one or more third-party systems from the user device. Each of the one more third-party systems is configured to store one or more files including datasets associated with at least one campaign.

In operation 1204, the computing system can store metadata associated with the at least one campaign in the third database. In operation 1206 the computing system can generate a workflow (e.g., workflows 162 as shown in FIG. 1) for each third-party systems of the one or more third party systems. In operation 1208, the computing system can stream the one or more files including the datasets associated with the at least one campaign from each of the one or more third party systems, via each respective workflow.

In operation 1210, the computing system can capture a URL associated with the events of the datasets from the at least one of the one or more files. In operation 1212, the computing system can determine device and browser information associated with the events. In operation 914, the computing system can determine a geographic location associated with the events.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps may be replaced with a single element, component or step. Likewise, a single element, component or step may be replaced with a plurality of elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the present invention. Further still, other aspects, functions and advantages such as different combinations of the described embodiments are also within the scope of the present invention.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

We claim:

1. A system to provide real-time values determined based on aggregated data from disparate systems, the system comprising:
a plurality of third-party systems, each third party system of the plurality of third party systems configured to store a plurality of files including datasets of different types, associated with one or more campaigns, wherein each dataset can be associated with a unique transaction ID;
a computing system, in communication with the plurality of third party systems and including a first database and a second database, the computing system is configured to:
receive a selection of one or more third-party systems of the plurality of third party systems, each of the one more third-party systems configured to store one or more files of the plurality of files, including datasets associated with at least one campaign of the one or more campaigns,
stream the one or more files including the datasets associated with the at least one campaign from each of the one or more third party systems,
aggregate each of the datasets from the one or more files, into one or more groups based on the unique transaction ID associated with each of the datasets;
store the one or more groups of the datasets in the first database,
retrieve information associated with the at least one campaign and a user of the user device from the second database;
calculate one or more values associated with the at least one campaign based on the one or more groups of datasets and the information associated with the at least one campaign and a user; and
generate a report including the one or more values.

2. The system of claim 1, further comprising a user device associated with the user and in communication with the computing system, the user device configured to transmit the selection of one or more third party systems.

3. The system of claim 1, further comprising a streaming platform residing on the computing system, the streaming platform configured to stream each of the one or more files of the plurality of files to at least one topic of a plurality of topics based on the types of the datasets included in the one or more files.

4. The system of claim 1, wherein the computing system is further configured to:
breakdown the datasets from the one or more files;
filter the datasets; and
normalize the datasets.

5. The system of claim 4, wherein the computing system is further configured to:
apply one or more tags to each of the plurality of third-party systems; and
generate the unique transaction IDs associated with each of the datasets based on the one or more tags applied to each of the plurality of third-party systems.

6. The system of claim 5, wherein filtering the datasets includes removing at least one dataset associated with an invalid transaction ID.

7. The system of claim 5, further comprising a third database in communication with the computing system configured to store metadata associated with the at least one campaign.

8. The system of claim 1, wherein at least one of the one or more files includes datasets associated with events.

9. The system of claim 8, wherein the computing system is configured to:
capture a URL associated with the events of the datasets from the at least one of the one or more files;
determine device and browser information associated with the events; and
determine a geographic location associated with the events.

10. The system of claim 1, wherein the user devices includes a display configured to render the generated report.

11. A method to provide real-time values determined based on aggregated data from disparate systems, the method comprising:
storing, via each of a plurality of third-party systems, a plurality of files including datasets of different types, associated with one or more campaigns, wherein each dataset can be associated with a unique transaction ID;
receiving, via a computing system, in communication with the plurality of third party systems and including a first database and a second database, a selection of one or more third-party systems of the plurality of third party systems, each of the one more third-party systems configured to store one or more files of the plurality of files, including datasets associated with at least one campaign of the one or more campaigns,
streaming, via the computing system, the one or more files including the datasets associated with the at least one campaign from each of the one or more third party systems,
aggregating, via the computing system, each of the datasets from the one or more files, into one or more groups based on the unique transaction ID associated with each of the datasets;
storing, via the computing system, the one or more groups of the datasets in the first database,
retrieving, via the computing system, information associated with the at least one campaign and a user of the user device from the second database;
calculating, via the computing system, one or more values associated with the at least one campaign based on the one or more groups of datasets and the information associated with the at least one campaign and a user; and
generating, via the computing system, a report including the one or more values.

12. The method of claim 11, further comprising transmitting, via a user device associated with the user and in communication with the computing system, the selection of one or more third party systems.

13. The method of claim 11, further comprising streaming, via a streaming platform residing on the computing system, each of the one or more files of the plurality of files to at least one topic of a plurality of topics based on the types of the datasets included in the one or more files.

14. The method of claim 11, further comprising:
breaking down, via the computing system, the datasets from the one or more files;
filtering, via the computing system, the datasets; and
normalizing, via the computing system, the datasets.

15. The method of claim 14, further comprising:
applying, via the computing system, one or more tags to each of the plurality of third-party systems; and
generating, via the computing system, the unique transaction IDs associated with each of the datasets based on the one or more tags applied to each of the plurality of third-party systems.

16. The method of claim 15, wherein filtering the datasets includes removing at least one dataset associated with an invalid transaction ID.

17. The method of claim 15, further comprising storing, via a third database in communication with the computing system, store metadata associated with the at least one campaign.

18. The method of claim 11, wherein at least one of the one or more files includes datasets associated with events.

19. The method of claim 18, further comprising:
capturing, via the computing system, a URL associated with the events of the datasets from the at least one of the one or more files;
determining, via the computing system, device and browser information associated with the events; and
determining, via the computing system, a geographic location associated with the events.

20. A non-transitory computer readable medium to provide real-time values determined based on aggregated data from disparate systems, wherein the instructions are executable by a processor to:
store, via each of a plurality of third-party systems, a plurality of files including datasets of different types, associated with one or more campaigns, wherein each dataset can be associated with a unique transaction ID;
receive, via a computing system, in communication with the plurality of third party systems and including a first database and a second database, a selection of one or more third-party systems of the plurality of third party systems, each of the one more third-party systems configured to store one or more files of the plurality of files, including datasets associated with at least one campaign of the one or more campaigns,
stream, via the computing system, the one or more files including the datasets associated with the at least one campaign from each of the one or more third party systems,
aggregate, via the computing system, each of the datasets from the one or more files, into one or more groups based on the unique transaction ID associated with each of the datasets;
store, via the computing system, the one or more groups of the datasets in the first database,
retrieve, via the computing system, information associated with the at least one campaign and a user of the user device from the second database;
calculate, via the computing system, one or more values associated with the at least one campaign based on the one or more groups of datasets and the information associated with the at least one campaign and a user; and
generating, via the computing system, a report including the one or more values.
